(19) United States
(12) Patent Application Publication
(10) Pub. No.: US 2008/0104270 A1
(43) Pub. Date: May 1, 2008

(54) Method and apparatus for communicating information about a data reception environment

(75) Inventors: Min-ho Lee, Gwacheon-si (KR); Cheol-ju Hwang, Yongin-si (KR); Han-sung Kim, Seongnam-si (KR); Soo-hong Park, Gwangju-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/712,900

(22) Filed: Mar. 2, 2007

(30) Foreign Application Priority Data
Oct. 27, 2006 (KR) 2006-105274

(51) Int. Cl. G06F 15/16

(52) U.S. Cl. 709/237

(57) ABSTRACT

A method and apparatus for communicating data. The method of receiving data by a first device from a second device includes generating a session initiation protocol (SIP) message including information on a data reception environment of the first device; transmitting the generated message to the second device; and receiving data transmitted by the second device based on the transmitted information. Accordingly, data transmission in consideration of a reception environment of a device for receiving data is possible, so that the quality of a data service is guaranteed.

### CROSS-REFERENCE TO RELATED APPLICATIONS

This application claims the benefit of Korean Application No. 2006-105274, filed in the Korean Intellectual Property Office on Oct. 27, 2006, the disclosure of which is incorporated herein by reference.

### BACKGROUND OF THE INVENTION

1. Field of the Invention

Aspects of the present invention relate to a method and apparatus for communicating data, and more particularly, to a method and apparatus for communicating data using a session initiation protocol (SIP) message.

2. Description of the Related Art

With the development of wired/wireless communication technology, various kinds of data services supporting multimedia communication have been provided. In a data service such as voice over Internet protocol (VoIP) or Internet protocol television (IPTV), real-time data communication is most important due to the need to guarantee a quality of service (QoS) when voice and image data is continuously transmitted and received in real-time.

FIG. 1 is a view showing an example of a change in a reception environment while data is being transmitted. A first device 11 receives data from a second device 12. In operation 101, the second device 12 transmits data to the first device 11 at a data transmission speed of 1 Mbps. Since the first device 11 belongs to a wireless local area network (LAN) network 130 currently having a maximum transmission speed of 2 Mbps, the first device 11 can continuously receive the data transmitted by the second device 12.

In operation 102, the first device 11 hands over to a wideband code division multiple access (WCDMA) network 140 having a maximum transmission speed of 384 Kbps. The first device 11 has both a wireless LAN module and a WCDMA network module. In operation 103, the second device 12 transmits data at the data transmission speed of 1 Mbps to the first device 11 in a similar manner to that before the hand-over occurred. Since the first device 11 is handed over to the WCDMA network 140 having a maximum transmission speed of 384 Kbps, the first device 11 cannot receive all of the data even though the second device 12 transmits data at the speed of 1 Mbps, resulting in data loss. In a VoIP service, the data loss may manifest as a dropped or distorted call.

FIG. 2 is a view showing another example of a change in a reception environment while data is being transmitted. As in FIG. 1, in. FIG. 2 the first device 11 receives data from the second device 12. In operation 201, the second device 12 transmits data to the first device 11 at a data transmission speed of 384 Kbps. Since the first device 11 belongs to a wireless LAN network 230 currently having a maximum transmission speed of 384 Kbps, the first device 11 can continuously receive the data transmitted by the second device 12.

In operation 202, the first device 11 hands over to a wireless LAN network 240 having a maximum transmission speed of 2 Mbps. In operation 203, the second device 12 continues to transmit data to the first device 11 at a data transmission speed of 384 Kbps. Since the network 240 has a maximum transmission speed of 2 Mbps after the hand-over, data loss does not occur, unlike the environment of FIG. 1. Instead, inefficiency occurs since only 384 Kbps is used out of a bandwidth of 2 Mbps.

The characteristics of a network may change even when hand-over does not occur. For example, when the first device 11 communicates with the second device 12 in the wireless LAN network 130 or 240, another device may connect to an access point (AP) connected to the first device 11. The access point must then allocate network resources to the newly connected device. Consequently, the network resources allocated to the first device 11 are reduced, potentially causing a deterioration in the reception environment of the first device 11.

In addition to the aforementioned link (network) characteristics, hardware characteristics may influence the reception environment. For example, when a central processing unit (CPU) of the first device 11 has to process other operations prior to data reception, the first device 11 cannot receive all the data transmitted by the second device 12 even though the link characteristics have not changed.

Therefore, a method and apparatus for communicating data based on a reception environment of a device for receiving data is required.

### SUMMARY OF THE INVENTION

The present invention provides a method and apparatus for transceiving data in consideration of a reception environment of a device for receiving data and a computer-readable medium having embodied thereon a computer program for executing the method.

According to an aspect of the present invention, there is provided a method of receiving data by a first device from a second device, the method including generating a session initiation protocol (SIP) message including information on a data reception environment of the first device; transmitting the generated message to the second device; and receiving data transmitted by the second device based on the transmitted information.

According to another aspect of the present invention, the information on a data reception environment may include information on characteristics of a network link used to receive the data.

According to another aspect of the present invention, the information on a data reception environment may include information on a hardware resource of the first device that can be used to process the data.

According to another aspect of the present invention, there is provided a method of transmitting data by a second device to a first device, the method including receiving an SIP message from the first device including information on a data reception environment of the first device; controlling a quality of service (QoS) for data transmission based on the information; and transmitting data to the first device according to the controlled QoS.

According to another aspect of the present invention, the SIP message may be an INVITE message, an INFO message, or a NOTIFY message.

According to another aspect of the present invention, the controlling of the QoS may include at least one from among an amount of frames per second, a resolution, a data compression ratio, and a forward error correction method.

According to another aspect of the present invention, there is provided an apparatus for receiving data of a first device from a second device, the apparatus including a message generator to generate an SIP message including information on a data reception environment of the first device; a message transmitter to transmit the generated message to the second device; and a data receiver to receive data transmitted by the second device based on the transmitted information.

According to another aspect of the present invention, there is provided an apparatus for transmitting data of a second device to a first device, the apparatus including a message receiver to receive an SIP message including information on a data reception environment of the first device from the first device; a QoS controller to control a QoS for data transmission based on the information in the SIP message received by the message receiver; and a data transmitter to transmit data to the first device according to the controlled QoS.

According to another aspect of the present invention, there is provided a computer-readable medium having embodied thereon a computer program to execute the methods described above.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing an example of a change in a reception environment while data is being transmitted;

FIG. 2 is a view showing another example of a change in a reception environment while data is being transmitted;

FIG. 3 is a data flow diagram showing a technique of communicating data according to an embodiment of the present invention;

FIG. 4 is a flowchart of a technique of receiving data using a reception device according to an embodiment of the present invention;

FIG. 5 is a view showing an example of an INVITE message according to an embodiment of the present invention;

FIG. 6 is a view showing an example of an INFO message according to an embodiment of the present invention;

FIG. 7 is a flowchart of a technique of transmitting data using a transmission device according to an embodiment of the present invention;

FIG. 8 is a block diagram of an apparatus to receive data according to an embodiment of the present invention; and

FIG. 9 is a block diagram of an apparatus to transmit data according to an embodiment of the present invention.

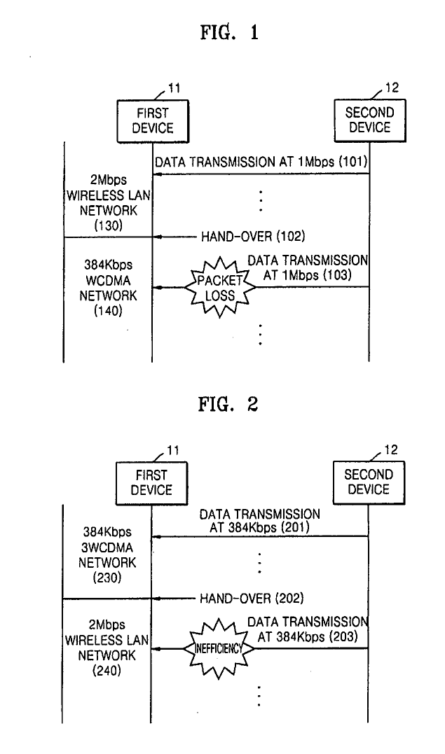

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

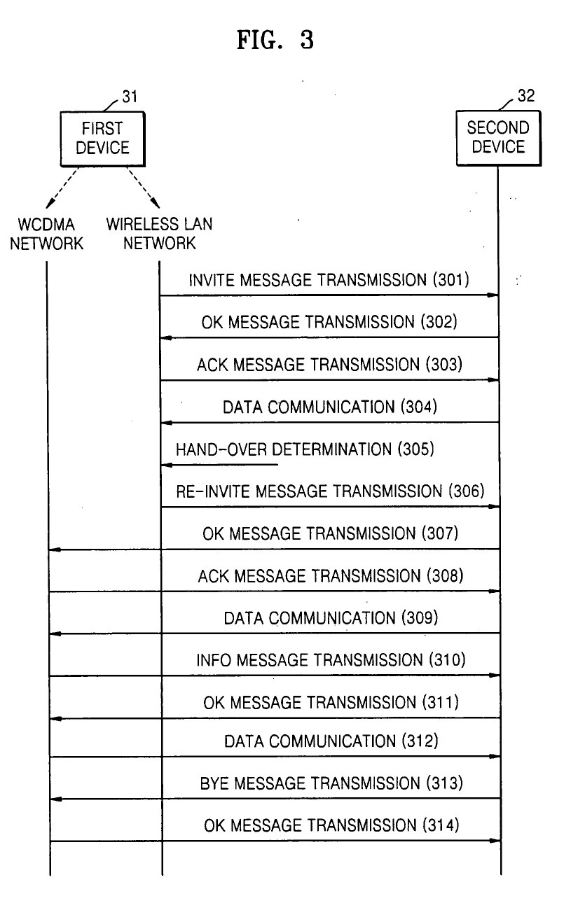

FIG. 3 is a data flow diagram showing a technique of communicating data according to an embodiment of the present invention. A first device 31 sets up a session by exchanging a session initiation protocol (SIP) message with a second device 32 in order to communicate with the second device 32. Since the first device 31 includes a wireless local area network (LAN) network module and a wideband code division multiple access (WCDMA) network module, the first device 31 can be handed over between the two networks and communicate with the second device 32. After the first device 31 communicates with the second device 32 using a wireless network, the first device 31 is handed over to a WCDMA network. According to other aspects of the present invention, the first device 31 may move from a WCDMA network to a wireless network. Additionally, according to other aspects of the present invention, the first device 31 and the second device 32 may communicate over any network.

In operation 301, the first device 31 transmits an INVITE message to the second device 32. The INVITE message is one of a plurality of SIP messages and is usually transmitted first in order to set up a session. The process of setting up a session according to the SIP generally involves exchanging three messages: an INVITE message, an OK message, and an acknowledgement (ACK) message. The INVITE message is usually transmitted first.

According to the SIP, an INVITE message usually includes information used to set up sessions. A message header includes information about a device transmitting the INVITE message and information identifying a device receiving the message. A message body includes information on a transmission protocol used for a session represented by a session description protocol (SDP), a media type, a codec, a sampling rate, or the like.

An INVITE message according to an embodiment of the present invention also includes information on a data reception environment of the first device 31 along with the aforementioned information used for setting sessions. Information on characteristics of a network link used to receive data and/or information on a hardware resource of the first device that can be used to process data are included in the INVITE message. The information included in the INVITE message will be described later in more detail.

In operation 302, the second device 32 transmits an OK message indicating that the INVITE message was received from the first device 31 correctly. If the INVITE message is transmitted for a Voice over Internet Protocol (VOIP) service, a RINGING message (not shown) is transmitted from the second device 32 to the first device 31 prior to the OK message.

The OK message transmitted from the second device 32 to the first device 31 may include information on a data reception environment of the second device 32. This is because the data reception environment of the second device 32 has to be taken into account, since the second device 32 not only transmits data but also receives data. For example, in VoIP, the two devices exchange voice data. Therefore, when the second device 32 is used for the VoIP service, the second device 32 has to perform data reception in addition to data transmission.

In operation 303, the first device 31 transmits an ACK message in response to the OK message. In operation 304, the first device 31 communicates with the second device 31 using the session set up in operations 301 through 303. When the session is set up for the VoIP service, voice data is communicated. When the session is set for a video on demand (VOD) service, audio and image data is communicated.

An SIP INVITE message in the related art includes only a message needed to set sessions. However, the SIP INVITE message according to an embodiment of the present invention also includes the aforementioned information on the data reception environment. The first device 31 and the second device 32 communicate with each other based on the information.

The INVITE message includes the information on the data reception environment of the first device 31. The second device 32 transmits data based on this information. When the first device 31 transmits data, the first device 31 examines its own transmission environment and transmits data accordingly. The data communication environment of the first device 31 is taken into account during both data transmission and data reception.

In operation 305, the first device 31 determines that a hand-over has been performed, for example, from the wireless LAN network to the WCDMA network. In operation 306, the first device 31 transmits a re-INVITE message to the second device 32. When the hand-over is performed, a corresponding change in the session occurs. Therefore, in order to reflect the changes to the session, the first device 31 transmits the re-INVITE message. The re-INVITE message may be transmitted using the wireless LAN network. As described above, information about a data reception environment of the first device 31 is included therein. Examples of the information on a data reception environment include information on characteristics of a network link used to receive data and information on a hardware resource of the first device 31 which can be used to process data.

When the second device 32 is handed over instead of the first device 31, the second device 32 transmits an INVITE message to the first device 31, so that the second device 32 generates and transmits the INVITE message including information on a data reception environment of the second device 32.

In operations 307 and 308, as in operations 302 and 303, an OK message and an ACK message are exchanged in order to set a session. However, operations 307 and 308 are different from operations 302 and 303 in that messages are exchanged through the WCDMA network after the first device 31 is handed over.

In operation 309, the first device 31 communicates data using the session set up in operations 306 through 308. The message transmitted by the first device 31 in operation 306 includes the information on the data reception environment of the first device 31. The two devices communicate based on the information.

In operation 310, the first device 31 transmits an INFO message to the second device 32. The INFO message contains control information generated during, and related to, a session. The INFO message is used to transmit information related to an application layer while maintaining the session. Any device related to the session can transmit the INFO message. In FIG. 3, both the first and second devices 31 and 32 can transmit the INFO message.

The INFO message according to an embodiment of the present invention includes the aforementioned information on the data reception environment in addition to the control information. When a change in the characteristics of the hardware resource or of the network link used to receive data occurs during the session, information on the change is included in the INFO message. Examples of changes include a change in the strength of a wireless signal in a wireless communication environment or a change in allocation of hardware resources (such as CPU or memory). When the second device 32 receives data from the first device 31, the information on the data reception environment of the second device 32 may be included in the INFO message transmitted to the first device 31.

In operation 311, the second device 32 transmits an OK message to the first device 31 in response to the INFO message in operation 311. In operation 312, the first device 31 communicates based on the information included in the INFO data. A change in the reception environment occurring during the session can be reflected in the data communication using the information included in the INFO message.

When all data communications are terminated, the second device 32 transmits a BYE message in operation 313 and receives an OK message in response to the BYE message, terminating the session.

Referring to FIG. 3, a technique of including information on a data reception environment of the first device in the INVITE message and the INFO message is described above. However, it will be understood by those of ordinary skill in the art that the aforementioned information may not be included in the INVITE message or the INFO message, but instead may be included in other SIP messages. The message which can include information on a data reception environment may be another SIP message, such as a NOTIFY message.

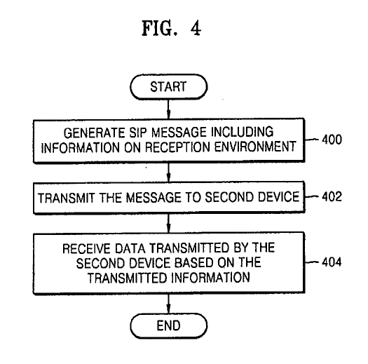

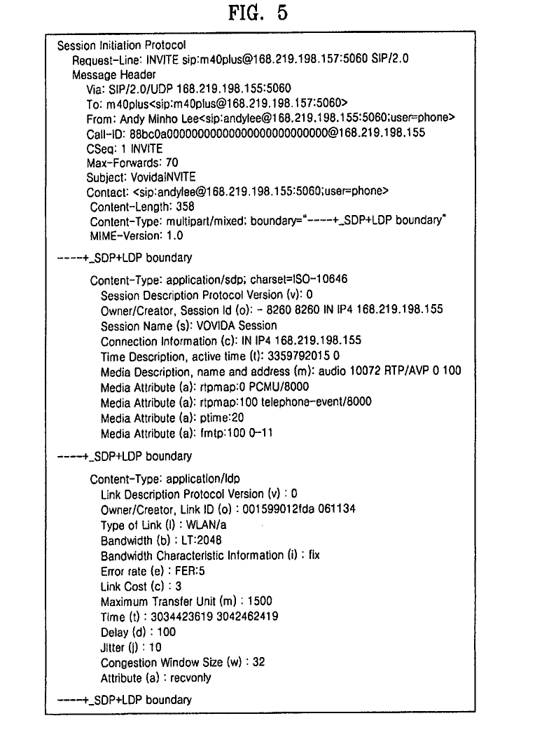

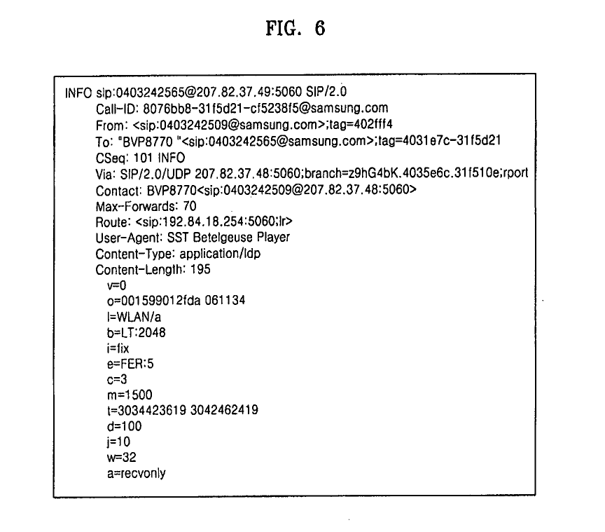

FIG. 4 is a flowchart of a method of receiving data using a reception device according to an embodiment of the present invention. In operation 400, the first device 31 (the reception device) generates an SIP message including information on a data reception environment of the first device 31. As described above, examples of the information on a data reception environment include information on characteristics of a network link used to receive data and/or information on a hardware resource of the first device 31 which can be used to process data. The information on a data reception environment can be included in an INVITE message, an INFO message, a NOTIFY message, or another SIP message. FIGS. 5 and 6 show examples of the information included in the INVITE message and the INFO message.

FIG. 5 is a view showing an example of an INVITE message according to an embodiment of the present invention. The INVITE message shown in FIG. 5 includes information on characteristics of a network link used to receive data. As described above, an INVITE message in the related art includes a message header and a message body represented by an SDP. Therefore, apart from a session description included in the INVITE message in the related art, the INVITE message according to an embodiment of the present invention may include the information on characteristics of a network link.

The message may be generated to have a type of ‘multipart/mixed’ or‘multipart/related’. In this case, a boundary for dividing a link description that is the information on characteristics of a link from the session description is defined in order to generate the message.

‘Link Description Protocol Version’ defines information on a protocol version which is used to write the link description.

‘Owner/Creator, Session Id’ defines information used to identify a device generating the session and information on a session identifier.

‘Type of Link’ defines a kind of a network link used to receive data. The kind of network link is not limited. In FIG. 5, a case where a network link based on 802.11, which is a standard of a wireless LAN, is used is shown. In addition to the wireless LAN, various types of network links such as Ethernet, wireless broadband (Wibro), high speed downlink packet access (HSDPA), or the like may be defined in the ‘Type of Link’.

‘Bandwidth’ defines information on a maximum bandwidth that can be used to receive data in a network link.

‘Bandwidth Characteristic Information’ defines whether the network link is ‘fix’, ‘adaptive’, or ‘contention-based’. A bandwidth that can be used for the network link is fixed, can be changed according to circumstances, or is determined by contents or a relationship between other devices.

‘Error rate’ defines an error rate of a network link. A bit error rate (BER) or a frame error rate (FER) is expressed as a percentage.

‘Link Cost’ defines a cost used for a network link. It is advantageous for the reception device to transmit less data through a link having a high link cost, and thus information about this is included in the SIP message.

‘Maximum Transfer Unit’ defines a maximum transfer unit in a network link. The maximum transfer unit in a corresponding link is the same as a maximum reception unit, so that information about this is included in the SIP message.

‘Time’ defines a time during which a link is used. A start and end time of a link connection is defined. When the time cannot be defined because the time is not determined, the time is set to ‘0’.

‘Encryption key’ defines an encryption key used for data encryption.

‘Attribute’ is information allocated to an application for transmitting/receiving the SIP message and may be different according to applications.

‘Delay’ defines a delay time of a network link.

‘Jitter’ defines a jitter time in a network link. The application of the reception device has to know the jitter time in order to be used for a real-time transmission and synchronization. Information about the jitter may therefore be included in the SIP message.

‘Congestion window size’ defines information on the amount of packets which can be transmitted using congestion control.

The information on characteristics of a network link shown in FIG. 5 are only examples; any information affecting data communication between the first and second devices 31 and 32 can be included in the INVITE message as the information on the link characteristics.

In addition, the INVITE message may include information on a hardware resource which can be used to receive data in addition to the information on the link characteristics. The information on a hardware resource may include information on a CPU, a memory, or the like which can be used to receive data. When a hardware resource such as a CPU, a memory, or the like, which can be used to receive data, is reduced because the first device 31 performs another operation, the first device 31 cannot correctly receive data transmitted from the second device 32. Therefore, the information on the hardware resource which can be used to receive data may be included in the SIP message and transmitted to the second device 32.

FIG. 6 is a view showing an example of an INFO message according to an embodiment of the present invention. The INFO message according to the SIP need not include the session description represented by the SDP unlike the INVITE message, and therefore the INFO message includes only the information on link characteristics in a message body. Each parameter is defined similarly to the INVITE message shown in FIG. 5. Similar to the INVITE message, according to the embodiment of the present invention, the INFO message may also include information on a hardware resource which can be used to receive data for the first device 31.

Returning to FIG. 4, in operation 402, the first device 31 transmits the message generated in operation 400 to the second device 32. In operation 404, the first device 31 receives data transmitted by the second device 32 based on the message transmitted to the second device 32. On the basis of the information on the data reception environment included in the message transmitted by the first device 31, the second device 32 controls a Quality of Service (QoS) for data transmission and transmits data to the first device 31 based on the QoS. The first device 31 then receives the data. A description of a control of the QoS will be described later.

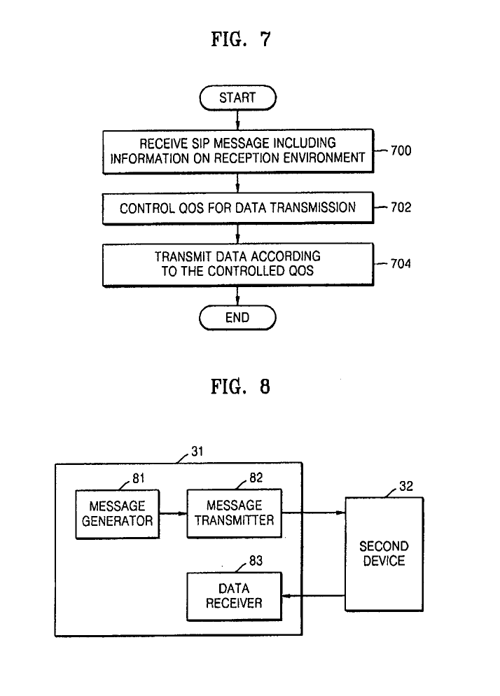

FIG. 7 is a flowchart of a technique of transmitting data using a transmission device according to an embodiment of the present invention. In operation 700, the second device 32 (the transmission device) receives the SIP message from the first device 31 including the information on a data reception environment of the first device 31. The SIP message including the information on a data reception device may be an INVITE message, an INFO message, an ACK message, or other SIP message. The received message is parsed in order to obtain the information included in the SIP message.

In operation 702, on the basis of the information on a data reception environment included in the SIP message received from the first device 31, the second device 32 controls the QoS for data transmission. A data transmission speed may be controlled or the data itself may be changed. Examples of changing the data itself include controlling scalable coded audio and controlling the scalability of video data. When the data is voice and image data, the amount of frames per second, the resolution, the data compression ratio, or a forward error correction method may be controlled in order to control the QoS of the data transmission. When the information on a network link and/or a hardware resource indicates an improved reception environment, a data transmission speed may be increased in order to transmit data within a short time, or the scalability may be controlled in order to transmit data having high quality image and voice to the first device 31. In addition, a transmission path may be changed. Any method of optimizing the data transmission can be performed in operation 702. In operation 704, the second device 32 transmits the data controlled according to the QoS in operation 702 to the first device 31.

FIG. 8 is a block diagram of an apparatus to receive data according to an embodiment of the present invention. In FIG. 8, the first device 31 is the reception device and the second device 32 is a transmission device for transmitting data to the first device 31. The first device 31 includes a message generator 81, a message transmitter 82, and a data receiver 83.

The message generator 81 generates an SIP message including information on a data reception environment of the first device 31. As described above, the information on a data reception environment includes information on characteristics of a network link used to receive data and/or information on a hardware resource of the first device which can be used to process data.

The message transmitter 82 transmits a message including the information on a data reception environment generated by the message generator 81 to the second device 32. The information on a data reception environment may be included in an INVITE message, an INFO message, a NOTIFY message, or another SIP message.

The data receiver 83 receives data transmitted by the second device 32 based on the message transmitted by the message transmitter 82 to the second device 32. The second device 32 controls a QoS for data transmission based on the information on a data reception environment included in the message transmitted by the first device 31 and transmits data to the first device 31. The first device 31 receives the data using the data receiver 83.

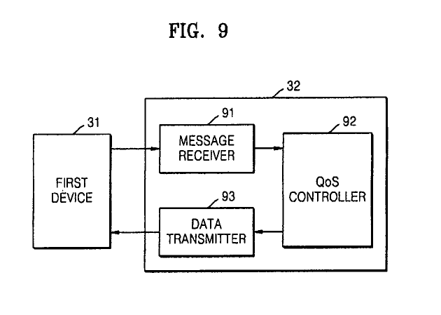

FIG. 9 is a block diagram of an apparatus for transmitting data of a transmission device according to an embodiment of the present invention. Similar to the apparatus illustrated in FIG. 8, in FIG. 9, the first device 31 is a reception device to receive data and the second device 32 is a transmission device transmitting data to the first device 31. The second device 32 includes a message receiver 91, a QoS controller 92, and a data transmitter 93.

The message receiver 91 receives an SIP message including information on a data reception environment of the first device 31 from the first device 31. The SIP message including the information on a data reception environment may be an INVITE message, an INFO message, or a NOTIFY message. The message receiver 91 may parse the received SIP message to extract the information on a data reception environment.

The QoS controller 92 controls a QoS for data transmission based on the information on a data reception environment included in the SIP message received from the first device 31. Any method of optimizing data transmission, such as controlling data transmission speed, changing data scalability, or changing a transmission path, may be performed by the QoS controller 92.

The data transmitter 93 transmits data to the first device 31 according to the QoS controlled by the QoS controller 92. Accordingly, the second device 32 transmits data based on a reception environment of the reception device, so that it is possible to prevent data loss during transmission and inefficiency of data transmission.

The second device 32 receives information on a network and/or information on hardware characteristics through an SIP message, and transmits data which is optimized according to the characteristics. Therefore, it is possible to guarantee a QoS in a voice over Internet protocol (VoIP) or an Internet protocol television (IPTV) in which real-time data communication is most important.

The techniques for guaranteeing a QoS (quality of service) according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc., including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention. Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of receiving data by a first device from a second device, the method comprising:
generating an SIP (session initiation protocol) message including information on a data reception environment of the first device;
transmitting the generated message to the second device; and
receiving data transmitted by the second device based on the transmitted information.

2. The method of claim 1, wherein the information on the data reception environment comprises information on characteristics of a network link used to receive the data.

3. The method of claim 1, wherein the information on the data reception environment comprises information on a hardware resource of the first device that is usable to process the data.

4. The method of claim 1, wherein the SIP message is one of an INVITE message, an INFO message, or a NOTIFY message.

5. A method of transmitting data from a second device to a first device, the method comprising:
receiving an SIP (session initiation protocol) message from the first device including information on a data reception environment of the first device;
controlling a QoS (quality of service) for data transmission based on the information; and
transmitting data to the first device according to the controlled QoS.

6. The method of claim 5, wherein the information on the data reception environment comprises information on characteristics of a network link used to receive the data.

7. The method of claim 5, wherein the information on the data reception environment comprises information on a hardware resource of the first device that is usable to process the data.

8. The method of claim 6, wherein the SIP message is one of an INVITE message, an INFO message, or a NOTIFY message.

9. The method of claim 5, wherein the controlling of the QoS comprises controlling at least one from among an amount of frames per second, a resolution, a data compression ratio, and a forward error correction method.

10. An apparatus for receiving data of a first device from a second device, the apparatus comprising:
a message generator to generate an SIP message including information on a data reception environment of the first device;
a message transmitter to transmit the generated message to the second device; and
a data receiver to receive data transmitted by the second device based on the transmitted information.

11. The apparatus of claim 10, wherein the information on the data reception environment comprises information on characteristics of a network link used to receive the data.

12. The apparatus of claim 10, wherein the information on the data reception environment comprises information on a hardware resource of the first device that is usable to process the data.

13. The apparatus of claim 10, wherein the SIP message is an INVITE message, an INFO message, or a NOTIFY message.

14. An apparatus to transmit data from a second device to a first device, the apparatus comprising:
a message receiver to receive an SIP message from the first device including information on a data reception environment of the first device;
a QoS controller to control a QoS for data transmission based on the information in the SIP message received by the message receiver; and
a data transmitter to transmit data to the first device according to the controlled QoS.

15. The apparatus of claim 14, wherein the information on the data reception environment comprises information on characteristics of a network link used to receive the data.

16. The apparatus of claim 14, wherein the information on the data reception environment comprises information on a hardware resource of the first device that is usable to process the data.

17. The apparatus of claim 14, wherein the SIP message is one of an INVITE message, an INFO message, or a NOTIFY message.

18. A computer-readable medium having embodied thereon a computer program to execute the method of claim 1.

19. A computer-readable medium having embodied thereon a computer program to execute the method of claim 5.

20. The method according to claim 1, wherein the information comprises at least one of a link description protocol version; an owner; a session ID; a type of link; a bandwidth; bandwidth characteristic information; an error rate; a link cost; a maximum transfer unit; a time; an encryption key; an attribute; a delay; jitter; or congestion window size.

21. The method according to claim 4, wherein the information comprises at least one of a link description protocol version; an owner; a session ID; a type of link; a bandwidth; bandwidth characteristic information; an error rate; a link cost; a maximum transfer unit; a time; an encryption key; an attribute; a delay; jitter; or congestion window size.

22. The apparatus according to claim 10, wherein the information comprises at least one of a link description protocol version; an owner; a session ID; a type of link; a bandwidth; bandwidth characteristic information; an error rate; a link cost; a maximum transfer unit; a time; an encryption key; an attribute; a delay; jitter; or congestion window size.

23. The apparatus according to claim 14, wherein the information comprises at least one of a link description protocol version; an owner; a session ID; a type of link; a bandwidth; bandwidth characteristic information; an error rate; a link cost; a maximum transfer unit; a time; an encryption key; an attribute; a delay; jitter; or congestion window size.

24. A method of guaranteeing a QoS (quality of service), comprising:
detecting a change in a data reception/transmission environment;
transmitting an SIP (session initiation protocol) message in response to the change in the data reception environment, the message including information about the changed data reception/transmission environment;
communicating with a device based on the information about the changed data reception environment.

25. The method according to claim 24, wherein the SIP message is a re-INVITE message.

26. The method according to claim 24, wherein the device is a mobile device.

27. The method according to claim 24, wherein the change in the data reception/transmission environment is a change in strength of a wireless signal.

28. The method according to claim 24, wherein the change in the data reception/transmission environment is a change in allocation of a hardware resource.

29. A method of guaranteeing a QoS (quality of service), comprising:
setting up a session between a first device and a second device using SIP (session initiation protocol);
communicating using the session;
transmitting a message from one of the first device and second device to the other of the first device and the second device, the message including information about a changed data reception/transmission environment;
communicating based on the information; and
terminating the session.

30. The method according to claim 29, wherein the change in the data reception/transmission environment is a change in strength of a wireless signal.

31. The method according to claim 29, wherein the change in the data transmission/reception environment is a change in allocation of a hardware resource.

32. The method according to claim 29, wherein at least one of the first device and the second device is a mobile device.
